(19) United States
(12) Patent Application Publication
(10) Pub. No.: US 2025/0061379 A1
(43) Pub. Date: Feb. 20, 2025

(54) COMPUTER-READABLE RECORDING MEDIUM STORING PIPELINE SET GENERATION PROGRAM, PIPELINE SET GENERATION METHOD, AND INFORMATION PROCESSING APPARATUS

(71) Applicant: Fujitsu Limited, Kawasaki-shi (JP)

(72) Inventor: Akira URA, Yokohama (JP)

(73) Assignee: Fujitsu Limited, Kawasaki-shi (JP)

(21) Appl. No.: 18/782,068

(22) Filed: Jul. 24, 2024

(30) Foreign Application Priority Data
Aug. 14, 2023 (JP) 2023-132155

(51) Int. Cl. G06N 20/00

(52) U.S. Cl. CPC G06N 20/00

(57) ABSTRACT

A non-transitory computer-readable recording medium stores a pipeline set generation program causing a computer to execute a process including: acquiring, based on a plurality of tasks, a pipeline set in which each pipeline includes a machine learning model; generating a second pipeline by executing a simplification process which includes at least one of a process of deleting a component included in the pipeline and a process of changing a hyper parameter of the component included in the pipeline to a default value on a first pipeline of the pipeline set; acquiring an evaluation value of the second pipeline by executing the second pipeline for the plurality of tasks; and adding the second pipeline to the pipeline set based on the evaluation value.

### CROSS-REFERENCE TO RELATED APPLICATION

This application is based upon and claims the benefit of priority of the prior Japanese Patent Application No. 2023-132155, filed on Aug. 14, 2023, the entire contents of which are incorporated herein by reference.

### FIELD

The embodiments discussed herein are related to a non-transitory computer-readable recording medium storing a pipeline set generation program, a pipeline set generation method, and an information processing apparatus.

### BACKGROUND

In analysis using machine learning, a machine learning model to be used or a machine learning algorithm such as a format of data to be input varies depending on data to be analyzed or a purpose. For the machine learning model, prediction accuracy may be improved by appropriately tuning a hyper parameter. Therefore, in the related art, in a case where analysis using machine learning is performed, processing and shaping on data, feature quantity engineering, optimization of hyper parameters, design of a machine learning model, and the like are manually performed by experts of machine learning.

Japanese Laid-open Patent Publication No. 2022-42497, Japanese Laid-open Patent Publication No. 2021-2315, U.S. Patent Application Publication No. 2022/0051049, and U.S. Patent Application Publication No. 2021/0097444 are disclosed as related art.

### SUMMARY

According to an aspect of the embodiments, a non-transitory computer-readable recording medium stores a pipeline set generation program causing a computer to execute a process including: acquiring, based on a plurality of tasks, a pipeline set in which each pipeline includes a machine learning model; generating a second pipeline by executing a simplification process which includes at least one of a process of deleting a component included in the pipeline and a process of changing a hyper parameter of the component included in the pipeline to a default value on a first pipeline of the pipeline set; acquiring an evaluation value of the second pipeline by executing the second pipeline for the plurality of tasks; and adding the second pipeline to the pipeline set based on the evaluation value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing apparatus according to an embodiment;

FIG. 2 is a diagram illustrating an example of a pipeline;

FIG. 3 is a diagram illustrating an example of generation of an initial pipeline set;

FIG. 4 is a diagram illustrating an example of simplification on the pipeline;

FIG. 5 is a diagram illustrating an example of a replacement process on the pipeline;

FIG. 6 is a flowchart of a generation process of a pipeline set of a robust pipeline according to the embodiment; and

FIG. 7 is a hardware configuration diagram of a computer.

### DESCRIPTION OF EMBODIMENTS

In this manner, in order to appropriately perform analysis using machine learning, advanced knowledge or techniques of data science are demanded. Therefore, there is a high hurdle for general users to use the machine learning. Research on automation of machine learning by automated machine learning (AutoML) that enables analysis using machine learning without advanced technique or knowledge is being developed. For AutoML, processing and shaping on data, feature quantity engineering, generation of a machine learning model, and the like are automatically performed.

A set of a series of flow processes including a plurality of pre-processes such as processing and shaping on data, feature quantity engineering, and adjustment of hyper parameters, and prediction using data generated in each process and a machine learning model is referred to as a “pipeline”. For example, the pipeline represents a series of processes in which a prediction process using a learning machine including a machine learning model is performed after 0 or more pre-processes. The pipeline includes hyper parameters in each process.

A set of pieces of information to be predicted in which designation of an objective variable, designation of an evaluation index, or the like is added to a data set is referred to as a “task”. For example, AutoML determines an appropriate pipeline for a specific task which is input. Meanwhile, the appropriate pipeline here is a pipeline having a certain degree of prediction accuracy, and may not be an optimal pipeline.

By holding a pipeline set of a small number of robust pipelines having a certain degree of prediction accuracy for many tasks in AutoML, it is possible to quickly determine an appropriate pipeline for a specific task. Therefore, it may be said that holding a pipeline set of a small number of robust pipelines having a certain degree of prediction accuracy in many tasks as pipelines of selection candidates is a promising way for AutoML to quickly and appropriately determine a pipeline.

As a technique for holding such a set of pipelines that are selection candidates, there is a technique in which AutoML is executed for a large number of tasks, and a pipeline set that is a subset thereof is selected from among appropriate pipelines for each task selected by AutoML.

As another technique for automating machine learning, there is a technique as described below. For example, a technique is proposed in which a set corresponding to a new project is searched from existing projects based on a new data set and a task, and a new pipeline generated by merging pipelines of the project as a search result is applied to the new project. A technique is proposed in which each machine learning model is generated by using a plurality of initial machine learning pipelines determined based on a type of training data and a model category, and a machine learning model to be used is determined from an evaluation result of each machine learning model. A technique is proposed in which a group of pipelines is determined based on pipeline setting metadata, a hyper parameter set for each pipeline is generated, performance of each pipeline is ranked, and a candidate pipeline is selected. A technique is proposed in which a target string in a provided data set is specified and an optimized pipeline is generated based on the specified target string and a provided search budget.

Meanwhile, the appropriate pipeline for the specific task is not necessarily the robust pipeline. For example, the appropriate pipeline for the specific task is specialized for the specific task, and may not be robust in a case where another pipeline is included. Therefore, a pipeline set obtained as a subset of a set of appropriate pipelines for each task is not necessarily sufficiently robust. Accordingly, it is difficult to improve convenience of automation of the machine learning.

Even with the technique of merging the pipelines of the project searched based on the new data set or the like to generate the new pipeline and applying the new pipeline to the new project, robustness is not ensured by the merging, and it is difficult to obtain a robust pipeline set. None of the technique of determining a machine learning model to be used from the evaluation result of the model, the technique of selecting a candidate by ranking the performance of the pipeline, and the technique of generating the pipeline based on the target string and the search budget considers robustness. Therefore, it is difficult to obtain a robust pipeline set by using any of the techniques. Accordingly, it is difficult to improve convenience of automation of the machine learning.

In consideration of the circumstances described above, an object of the disclosed technique is to provide a pipeline set generation program, a pipeline set generation method, and an information processing apparatus that improve convenience of automation of machine learning.

Hereinafter, an embodiment of a pipeline set generation program, a pipeline set generation method, and an information processing apparatus disclosed in the present application will be described in detail with reference to the drawings. The pipeline set generation program, the pipeline set generation method, and the information processing apparatus disclosed in the present application are not limited to the following embodiment.

### Embodiment

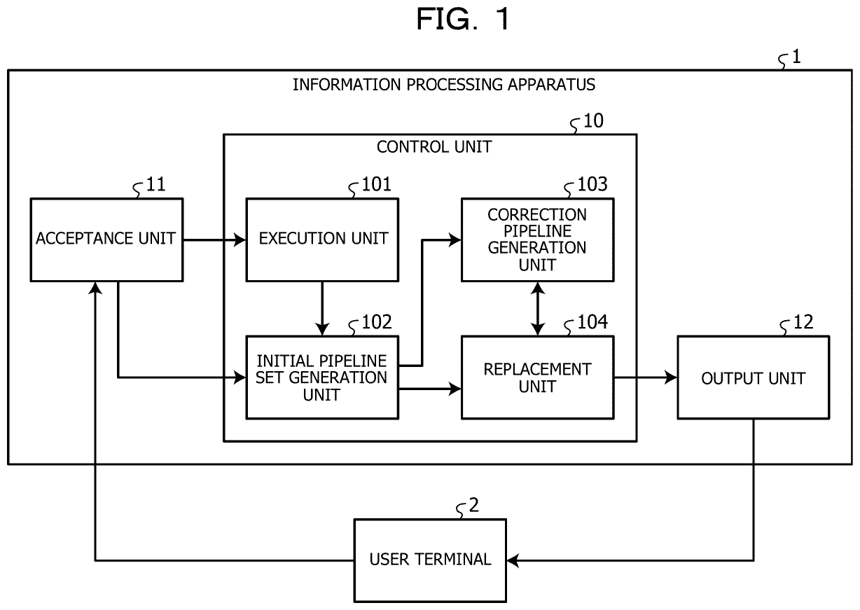

FIG. 1 is a block diagram of an information processing apparatus according to an embodiment. An information processing apparatus 1 is coupled to a user terminal 2 serving as an input source of data or an output destination of a processing result. The information processing apparatus 1 includes a control unit 10, an acceptance unit 11, and an output unit 12.

The acceptance unit 11 accepts an input of a task set and an AutoML program from the user terminal 2. The AutoML program is a program used by a user for analysis using machine learning. The task set is a set of a plurality of tasks. Preferably, the task is similar to a task used when the user performs the machine learning by using the AutoML program. The AutoML program outputs an appropriate pipeline based on the input task. The appropriate pipeline for a specific task is a pipeline having the best prediction performance, among pipelines that may be generated for the specific task.

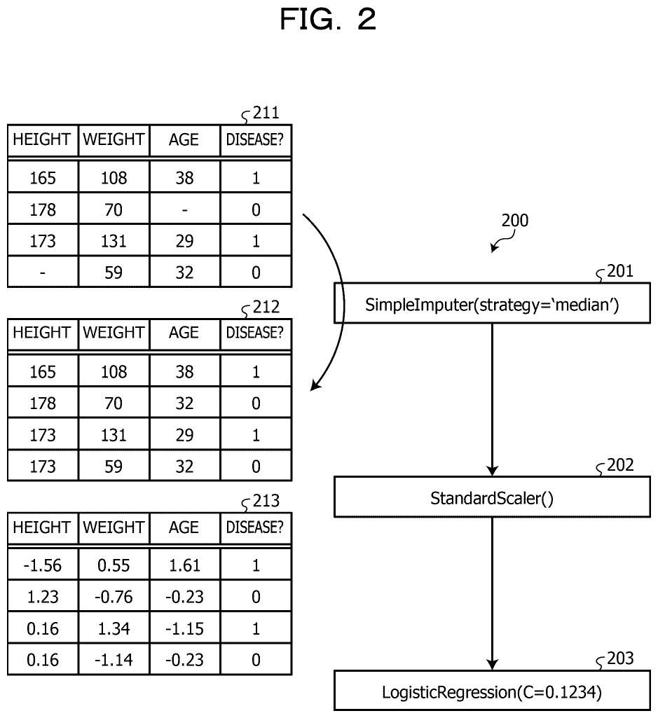

FIG. 2 is a diagram illustrating an example of a pipeline. The pipeline used in the following description will be described with reference to FIG. 2. A pipeline 200 in FIG. 2 is an example of a pipeline in which it is determined whether or not to be taken with a disease, from a given data set by using “disease” as an objective variable.

The pipeline 200 includes components 201 to 203. The component 201 executes a process for filling a missing value of the given data set. “strategy=‘median’” in the component 201 represents a hyper parameter. The component 202 executes a normalization process such that an average is 0 and a standard deviation is 1. The component 203 is a learning machine. C=0.1234 in the component 203 is a hyper parameter.

For example, the pipeline 200 receives a data set of a height, a weight, and an age indicated in a table 211 as an input, and outputs whether or not to be taken with a disease for each combination of the height, the weight, and the age. In this case, the missing value in the table 211 is filled by the component 201, and the data set is converted into a data set indicated in the table 212.

Next, by the component 202, each data in the table 212 is normalized, and the data set is converted into a data set illustrated in a table 213. In this case, since the disease is an objective variable, a pre-process is not applied. After that, a determination result for being taken with the disease is output from the learning machine, by using the data set including the height, the weight, and the age on which the pre-process is performed in the component 203, as an input.

The description will be continued with reference to FIG. 1. The acceptance unit 11 outputs the accepted task set and AutoML program to an execution unit 101 of the control unit 10.

In the present embodiment, in a case where an appropriate pipeline obtained by AutoML for a certain specific task is determined, prediction performance of a target pipeline to be evaluated is represented by a deviation degree corresponding to a difference from the prediction performance of the appropriate pipeline. For example, the deviation degree is an index indicating how much prediction performance of a specific task in a case where a target pipeline is used deviates from prediction performance of the specific task in a case where an appropriate pipeline for the specific task is used. For example, when a deviation degree is represented by an expression, the deviation degree is represented as “deviation degree=(prediction performance of appropriate pipeline)−(prediction performance of target pipeline)”. The deviation degree may also be referred to as “regret”.

The acceptance unit 11 also accepts information on a target deviation degree, which is a target value of the deviation degree for each task, from the user terminal 2. The target deviation degree may be different or the same for each task. The acceptance unit 11 outputs the accepted target deviation degree to an initial pipeline set generation unit 102 of the control unit 10. An input of the target deviation degree may be performed in advance.

The control unit 10 acquires a subset from a pipeline set of the appropriate pipeline obtained from the AutoML program for each task of the task set. Next, the control unit 10 executes a simplification process including at least one of a process of deleting a component included in the pipeline and a process of changing a hyper parameter of the component included in the pipeline to a default value on a first pipeline included in the pipeline set to generate a second pipeline. Next, the control unit 10 executes the second pipeline for a plurality of tasks, and acquires an evaluation value of the second pipeline. Based on the evaluation value, the control unit 10 generates a new pipeline set by adding the second pipeline to the pipeline set.

Details of the control unit 10 will be described below. As illustrated in FIG. 1, the control unit 10 includes the execution unit 101, the initial pipeline set generation unit 102, a correction pipeline generation unit 103, and a replacement unit 104.

The execution unit 101 receives an input of a task set and an AutoML program from the acceptance unit 11. Next, the execution unit 101 executes the AutoML program for each task included in the task set. The execution unit 101 acquires an appropriate pipeline for each task output as a result of executing the AutoML program. The execution unit 101 outputs the acquired appropriate pipeline for each task to the initial pipeline set generation unit 102.

The initial pipeline set generation unit 102 receives an input of the appropriate pipeline for each task from the execution unit 101. The initial pipeline set generation unit 102 receives an input of a target deviation degree from the acceptance unit 11.

Next, for each pair of a task and a pipeline, the initial pipeline set generation unit 102 calculates an error representing a difference between a deviation degree and a target deviation degree. Here, the minimum value of the error is 0. For example, when the error is represented by an expression, the error may be represented as “error=max (deviation degree−target deviation degree, 0)”. “max” is a function for selecting a larger value of two elements. The error may also be referred to as “loss”. A case where the target deviation degree is set to 0, for example, a case where prediction performance of the target pipeline coincides with prediction performance of the appropriate pipeline is set as a target deviation degree, the error coincides with the deviation degree.

Next, the initial pipeline set generation unit 102 initializes the pipeline set to an empty set. Next, the initial pipeline set generation unit 102 repeats the following processes to generate an initial pipeline set. For example, the initial pipeline set generation unit 102 adds each pipeline not included in the pipeline set among the appropriate pipelines for each task to the pipeline set one by one. For each of the pipeline sets to which different pipelines are added, the initial pipeline set generation unit 102 calculates an error sum by adding the minimum values of the errors for each of the tasks included in the pipeline set for all the tasks. The initial pipeline set generation unit 102 adds a pipeline having the smallest error sum to the pipeline set.

The initial pipeline set generation unit 102 repeats addition of a pipeline to a pipeline set until a predetermined generation end condition of the initial pipeline set is satisfied. For example, the generation end condition is set based on an upper limit of the number of pipelines included in the pipeline set, an elapsed time, or the like. The initial pipeline set generation unit 102 outputs a pipeline set at a time point when the generation end condition is satisfied as an initial pipeline set to the correction pipeline generation unit 103 and the replacement unit 104. The initial pipeline set generation unit 102 outputs all the tasks and the prediction performance of the appropriate pipeline for all the tasks to the correction pipeline generation unit 103. The initial pipeline set is an example of a “pipeline set in which each pipeline acquired based on a plurality of tasks includes a machine learning model”.

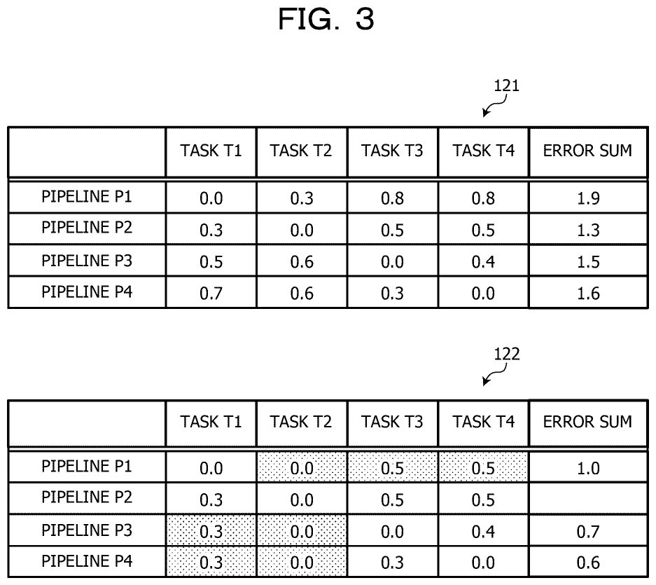

FIG. 3 illustrates an example of generation of an initial pipeline set. The example of the generation of the initial pipeline set by the initial pipeline set generation unit 102 will be described with reference to FIG. 3. Here, a case where a target deviation degree is 0, for example, an error coincides with a deviation degree will be described. Here, there are tasks T1 to T4, and pipelines P1 to P4 that are appropriate pipelines for the respective tasks T1 to T4. Tables 121 and 122 in FIG. 3 indicate an error for each set of the tasks T1 to T4 and the pipelines P1 to P4.

In a state in which a pipeline set is an empty set, the initial pipeline set generation unit 102 calculates errors for the tasks T1 to T4 of the pipelines P1 to P4 as illustrated in the table 121. In this case, since the pipeline set is an empty set, the minimum value of the error for each of the tasks T1 to T4 included in the pipeline set in a case where each of the pipelines P1 to P4 is added to the pipeline set one by one coincides with an error of each of the pipelines P1 to P4. For each of the pipelines P1 to P4, the initial pipeline set generation unit 102 simply obtains a sum of the respective errors, and calculates an error sum. In this case, since the error sum of the pipeline P2 is the smallest, the initial pipeline set generation unit 102 adds the pipeline P2 to the pipeline set.

Next, the initial pipeline set generation unit 102 adds one of the pipelines P1, P3, and P4 to a pipeline set including the pipeline P2 one by one, and obtains the minimum value of the error in each of the tasks T1 to T4. The table 122 indicates the minimum value of the error for each of the tasks T1 to T4 in a case where each of the pipelines P1, P3, and P4 is added to the pipeline set. The error of the pipeline P2 is written in a grayed-out portion in the table 122 since the error of the pipeline P2 is the minimum value. Since the errors of the added pipeline P1, P3, or P4 are smaller than the error of the pipeline P2, the errors of the pipeline P1, P3, or P4 are written in the other portions. For each of the pipelines P1, P3, and P4, the initial pipeline set generation unit 102 adds the errors in the table 122 to obtain an error sum. In this case, since the error sum of the pipeline P4 is the smallest, the initial pipeline set generation unit 102 adds the pipeline P4 to the pipeline set. For example, the pipeline set includes the pipeline P2 and the P4.

For example, when the pipeline P3 is added in the table 122, an error between the task T2 and the task T3 is 0, and prediction performance for some tasks is high. Meanwhile, by adding the pipeline P4, prediction performance of all the tasks T1 to T4 is improved, as compared with the case where the pipeline P3 is added, and the initial pipeline set generation unit 102 may generate a pipeline set having more robust pipelines.

The description will be continued with reference to FIG. 1. The correction pipeline generation unit 103 receives an input of an initial pipeline set from the initial pipeline set generation unit 102. Next, the correction pipeline generation unit 103 freely selects one pipeline from the initial pipeline set. The selected pipeline is an example of a “first pipeline”. The correction pipeline generation unit 103 generates a correction pipeline by executing a simplification process of adding a change of simplifying the pipeline on the selected pipeline. This correction pipeline is an example of a “second pipeline”.

For example, the simplification process includes a change of deleting one pre-process component or a change of setting a hyper parameter of a component to a default value. The simplification process includes a change of a learning machine to a learning machine having a simpler configuration, a change of a hyper parameter for determining a complexity of a pipeline in a direction in which the complexity of the pipeline is to be simplified, and the like. The component corresponds to a process at each stage included in the pipeline.

By deleting one pre-process component, the number of processing stages is reduced by one, so that the pipeline may be simplified. Since a simple value is used as the default value of the hyper parameter of the component as compared with a value obtained by learning, it may be said that the pipeline is simplified by setting the hyper parameter of the component to the default value. The change of a learning machine to a learning machine having a simpler configuration includes, for example, a change of a learning machine to a linear model of a multilayer perceptron, and the like. The change of a hyper parameter for determining a complexity of a machine learning model to a hyper parameter having non-complexity includes a change of increasing a value of a regularization term (such as an increase in C of LogisticRegression), a change of reducing a depth of a decision tree, or the like.

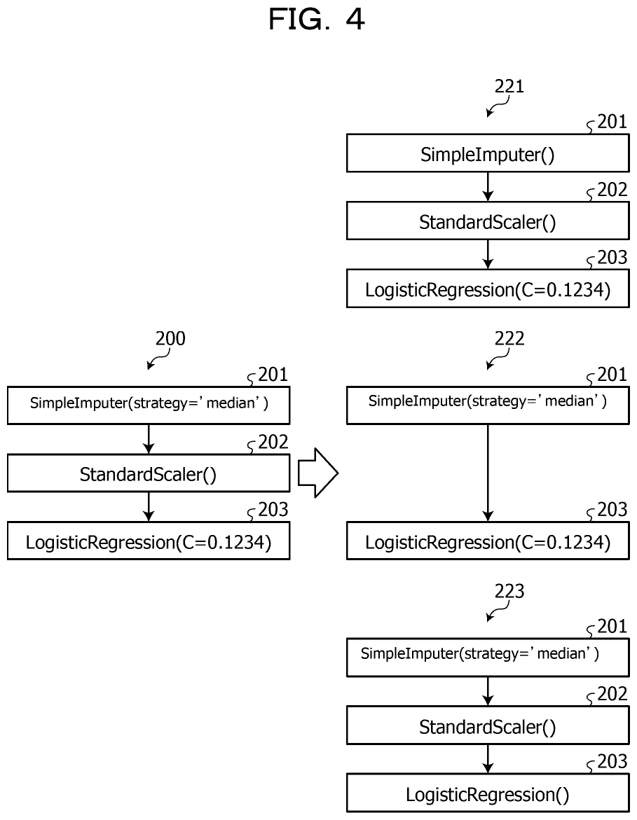

FIG. 4 is a diagram illustrating an example of simplification on a pipeline. The example of the simplification on the pipeline will be described with reference to FIG. 4. Here, a case where the same pipeline 200 as in FIG. 3 is simplified will be described.

For example, the correction pipeline generation unit 103 generates a correction pipeline 221 by applying a change of a hyper parameter of the component 201 of the pipeline 200 to a default value. As for the component 201 of the correction pipeline 221, the hyper parameter “strategy=‘median’” set in the component 201 of the pipeline 200 is removed and changed to a default value.

The correction pipeline generation unit 103 generates a correction pipeline 222 by adding a change of deleting the component 202 of the pipeline 200. The component 202 is removed, and the correction pipeline 222 has the components 201 and 203.

The correction pipeline generation unit 103 generates a correction pipeline 223 by applying a change of a hyper parameter of the component 203 of the pipeline 200 to a default value. As for the component 203 of the correction pipeline 223, the hyper parameter “c=0.1234” set in the component 203 of the pipeline 200 is removed and changed to the default value.

The correction pipeline generation unit 103 outputs the generated correction pipeline to the replacement unit 104. After that, upon receiving an instruction to generate a correction pipeline from the replacement unit 104, the correction pipeline generation unit 103 freely selects a pipeline again, performs a simplification process on the selected pipeline to create a correction pipeline, and outputs the correction pipeline to the replacement unit 104.

The replacement unit 104 receives, from the initial pipeline set generation unit 102, an input of an initial pipeline set, all tasks, and prediction performance of an appropriate pipeline for all the tasks. The replacement unit 104 receives the input of the correction pipeline from the correction pipeline generation unit 103.

Next, the replacement unit 104 calculates a deviation degree for each task in the correction pipeline. Next, the replacement unit 104 detects one pipeline in which an error sum is improved by changing with the correction pipeline in the initial pipeline set. The replacement unit 104 replaces the detected pipeline with the correction pipeline to generate a new pipeline set. In a case where there are a plurality of pipelines in which the error sum is improved, the replacement unit 104 may select a pipeline in which the error sum is smallest as a pipeline to be replaced.

The appropriate pipeline obtained by AutoML is an example of a “reference pipeline”. The deviation degree or the error sum is an example of an “evaluation value”. The replacement of the pipeline included in the pipeline set with the correction pipeline by the replacement unit 104 is an example of “addition of a second pipeline to a pipeline set”. The replacement may be considered as a procedure of adding a correction pipeline to a pipeline set and then deleting a corresponding original pipeline, and may be said to be one form of addition of a correction pipeline. Although the replacement is performed to set the number of pipeline sets to a certain number in the present embodiment, robustness of a pipeline included in the pipeline set is improved even when a correction pipeline is simply added to the pipeline set.

After that, the replacement unit 104 requests the correction pipeline generation unit 103 to generate a correction pipeline, and acquires the new correction pipeline. At this time, the replacement unit 104 may request generation of a correction pipeline based on a newly generated pipeline set or may request generation of the correction pipeline based on the initial pipeline set. By using the new correction pipeline, the replacement unit 104 replaces the pipeline included in the pipeline set.

The replacement unit 104 repeats the replacement of the pipeline until an end condition of the replacement process is satisfied. The end condition of the replacement process is, for example, whether the replacement is repeated a designated number of times or whether a designated time elapses. After the end condition of the replacement is satisfied, the replacement unit 104 outputs a pipeline set at that time to the output unit 12 as a pipeline set of a robust pipeline.

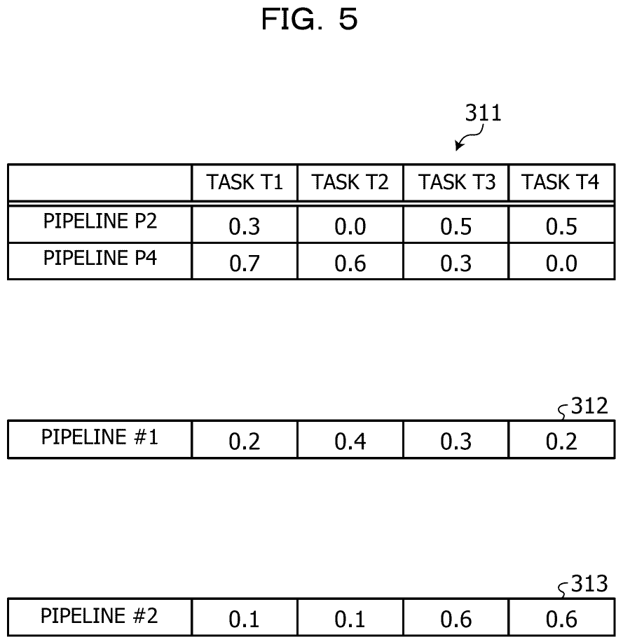

FIG. 5 is a diagram illustrating an example of a replacement process on a pipeline. Here, a case where the pipelines P2 and P4 illustrated in the table 311 are included in a pipeline set will be described. The replacement unit 104 calculates an error sum of the original pipeline set as 0.3+0.0+0.3+0.0=0.6.

For example, the replacement unit 104 acquires a pipeline #1 that is a correction pipeline 312. The replacement unit 104 calculates an error sum of 0.2+0.4+0.3+0.0=0.9 in a case where the pipeline #1 and the pipeline P2 are replaced with each other. The replacement unit 104 calculates an error sum of 0.2+0.0+0.3+0.2=0.7 in a case where the pipeline #1 and the pipeline P4 are replaced with each other. In this case, since the original error sum is not improved in any of the cases, the replacement unit 104 does not perform the pipeline replacement.

For example, the replacement unit 104 acquires a pipeline #2 that is a correction pipeline 313. The replacement unit 104 calculates an error sum of 0.1+0.1+0.3+0.0=0.5 in a case where the pipeline #2 and the pipeline P2 are replaced with each other. The replacement unit 104 calculates an error sum of 0.1+0.0+0.5+0.5=1.1 in a case where the pipeline #2 and the pipeline P4 are replaced with each other. In this case, since the error sum is improved by replacing the pipeline #2 with the pipeline P2, the replacement unit 104 replaces the pipeline #2 with the pipeline P2 to generate a new pipeline set.

The output unit 12 receives an input of a pipeline set of a robust pipeline from the replacement unit 104. The output unit 12 transmits the acquired pipeline set to the user terminal 2, and notifies a user of the acquired pipeline set. By executing the AutoML program using the pipeline set of the robust pipeline notified by the information processing apparatus 1, the user may acquire a pipeline having a certain degree of prediction performance in a short time.

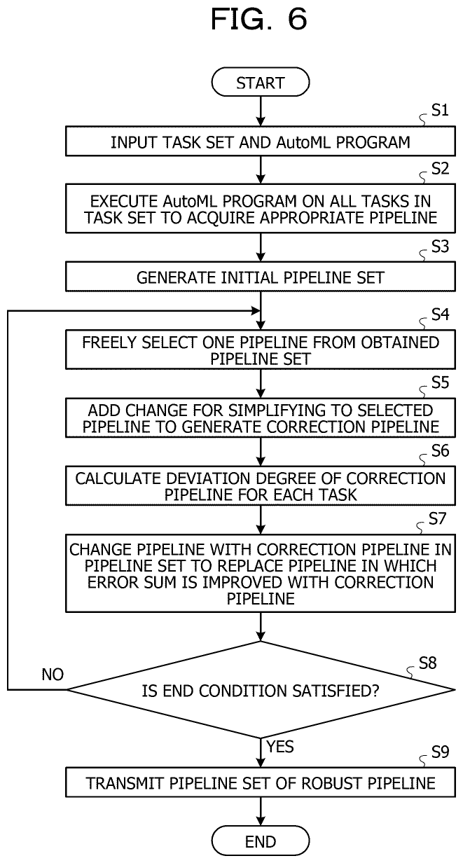

FIG. 6 is a flowchart of a generation process of a pipeline set of a robust pipeline according to the embodiment. Next, a flow of the generation process of the pipeline set of the robust pipeline by the information processing apparatus 1 according to the embodiment will be described with reference to FIG. 6.

A user inputs a task set and an AutoML program to the information processing apparatus 1 by using the user terminal 2 (step S1).

The acceptance unit 11 accepts the task set and the AutoML program input from the user terminal 2, and outputs the task set and the AutoML program to the execution unit 101. The execution unit 101 executes AutoML for all tasks of the task set, and acquires an appropriate pipeline for each task (step S2).

Among the appropriate pipelines, the initial pipeline set generation unit 102 adds each pipeline which is not included in a pipeline set to the pipeline set one by one, adds the minimum value of errors included in the pipeline set for all the tasks, and calculates an error sum. The initial pipeline set generation unit 102 generates an initial pipeline set, which is a first pipeline set, by repeatedly adding a pipeline having the smallest error sum to the pipeline set (step S3).

The correction pipeline generation unit 103 freely selects one pipeline from the pipeline set (step S4).

Next, the correction pipeline generation unit 103 generates a correction pipeline by adding a change of simplifying to the selected pipeline (step S5).

The replacement unit 104 calculates a deviation degree of the correction pipeline for each task (step S6).

Next, the replacement unit 104 specifies a pipeline in which an error sum is improved by changing with the correction pipeline in the pipeline set. The replacement unit 104 replaces the specified pipeline with the correction pipeline to generate a new pipeline set (step S7).

After that, the replacement unit 104 determines whether or not an end condition of the replacement process is satisfied (step S8). In a case where the end condition is not satisfied (no in step S8), the replacement unit 104 requests the correction pipeline generation unit 103 to create a correction pipeline, and the pipeline set generation process of the robust pipeline returns to step S4.

By contrast, in a case where the end condition is satisfied (Yes in step S8), the replacement unit 104 outputs the generated pipeline set to the output unit 12. The output unit 12 transmits the pipeline set of the robust pipeline input from the replacement unit 104 to the user terminal 2 (step S9).

### (Hardware Configuration)

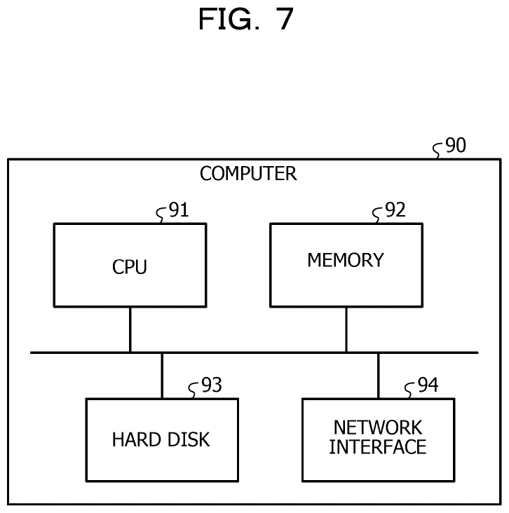

FIG. 7 is a hardware configuration diagram of a computer. The information processing apparatus 1 may be realized by a computer 90 illustrated in FIG. 7. Next, an example of the hardware configuration of the information processing apparatus 1 will be described with reference to FIG. 7.

As illustrated in FIG. 7, for example, the computer 90 includes a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the computer 90 and an external apparatus. For example, the network interface 94 relays communication between the user terminal 2 and the CPU 91. The network interface 94 realizes the functions of the acceptance unit 11 and the output unit 12.

The hard disk 93 is an auxiliary storage device. The hard disk 93 stores various programs including a program for realizing the function of the control unit 10 including the execution unit 101, the initial pipeline set generation unit 102, the correction pipeline generation unit 103, and the replacement unit 104 illustrated in FIG. 1.

The memory 92 is a main storage device. For example, a dynamic random-access memory (DRAM) may be used as the memory 92.

The CPU 91 reads various programs from the hard disk 93, develops the programs into the memory 92, and executes the programs. Thus, the CPU 91 realizes the function of the control unit 10 including the execution unit 101, the initial pipeline set generation unit 102, the correction pipeline generation unit 103, and the replacement unit 104 illustrated in FIG. 1.

As described above, the information processing apparatus according to the present embodiment selects a pipeline among appropriate pipelines obtained by AutoML for each task, and generates a pipeline set of a robust pipeline. The information processing apparatus generates a correction pipeline by executing a change of simplifying on the pipeline included in the generated pipeline set. In a case where the robustness is improved by replacing the pipeline with the correction pipeline, the information processing apparatus replaces the pipeline included in the pipeline set with the correction pipeline to generate a pipeline set of more robust pipelines.

Thus, the user may receive provision of a pipeline set of robust pipelines from the information processing apparatus, and may easily acquire a pipeline having a certain degree of prediction performance by executing automation of machine learning using the pipeline set. Accordingly, it is possible to improve convenience of the automation of the machine learning.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a pipeline set generation program causing a computer to execute a process comprising:
acquiring, based on a plurality of tasks, a pipeline set in which each pipeline includes a machine learning model;
generating a second pipeline by executing a simplification process which includes at least one of a process of deleting a component included in the pipeline and a process of changing a hyper parameter of the component included in the pipeline to a default value on a first pipeline of the pipeline set;
acquiring an evaluation value of the second pipeline by executing the second pipeline for the plurality of tasks; and
adding the second pipeline to the pipeline set based on the evaluation value.

2. The non-transitory computer-readable recording medium according to claim 1,
wherein in the acquiring of the evaluation value, for each task of the plurality of tasks, a difference between prediction accuracy of a reference pipeline and prediction accuracy of the second pipeline is acquired as the evaluation value.

3. The non-transitory computer-readable recording medium according to claim 1,
wherein in the acquiring of the pipeline set, a plurality of pipelines is acquired, each pipeline included in the plurality of pipelines is executed for each of the plurality of tasks, the evaluation value for each pipeline included in the plurality of pipelines for each task is acquired, and the pipeline set is acquired based on the evaluation value.

4. The non-transitory computer-readable recording medium according to claim 1,
wherein the simplification process includes a process of changing a learning machine to a learning machine having a simpler structure or a process of changing a hyper parameter for determining a complexity of a pipeline in a direction in which the complexity of the pipeline is to be simplified.

5. A pipeline set generation method causing a computer to execute a process comprising:
acquiring, based on a plurality of tasks, a pipeline set in which each pipeline includes a machine learning model;
generating a second pipeline by executing a simplification process which includes at least one of a process of deleting a component included in the pipeline and a process of changing a hyper parameter of the component included in the pipeline to a default value on a first pipeline of the pipeline set;
acquiring an evaluation value of the second pipeline by executing the second pipeline for the plurality of tasks; and
adding the second pipeline to the pipeline set based on the evaluation value.

6. An information processing apparatus comprising:
a memory; and
a processor coupled to the memory and configured to:
acquire, based on a plurality of tasks, a pipeline set in which each pipeline includes a machine learning model;
generate a second pipeline by executing a simplification process which includes at least one of a process of deleting a component included in the pipeline and a process of changing a hyper parameter of the component included in the pipeline to a default value on a first pipeline of the pipeline set;
acquire an evaluation value of the second pipeline by executing the second pipeline for the plurality of tasks; and
add the second pipeline to the pipeline set based on the evaluation value.
